(19) United States
(12) Patent Application Publication
(10) Pub. No.: US 2025/0355403 A1
(43) Pub. Date: Nov. 20, 2025

(54) CONTROL DEVICE FOR CLOCKWORK MOVEMENT, AND CORRESPONDING CLOCKWORK MOVEMENT AND TIMEPIECE

(71) Applicant: MANUFACTURE D'HORLOGERIE AUDEMARS PIGUET SA, Le Brassus (CH)

(72) Inventor: Julien MARTEL, Neuchâtel (CH)

(21) Appl. No.: 18/870,549

(22) PCT Filed: Jun. 8, 2023
(86) PCT No.: PCT/EP2023/065414

§ 371 Date: Nov. 29, 2024

(30) Foreign Application Priority Data
Jun. 9, 2022 (EP) 22178191.7

(51) Int. Cl. G04F 7/08

(52) U.S. Cl. CPC G04F 7/0866; G04F 7/0861

(57) ABSTRACT

A control device is disclosed, which comprises:
a lever movable between a rest position and a triggering position,
a spring arranged to return the lever in its rest position,
an actuating member movable between a neutral position and an actuating position in which it actuates a watch mechanism,
a mechanical energy storage member interposed between the lever and the actuating member in such a way that it is charged when the lever moves towards its triggering position, and can be discharged when the lever reaches its triggering position by moving the actuating member towards its actuating position,
the device comprising a locking member intended to release the actuating member only when the lever reaches its triggering position.

### TECHNICAL FIELD

The present invention relates to a control device for a watch movement, comprising:
a lever intended to be actuated, in response to an action by a user on an external control member, to move from a rest position to a triggering position,
an elastic return member arranged to return the lever to its rest position,
an actuating member movable between a neutral position and an actuating position in which it is intended to actuate a watch mechanism of the watch movement,
a mechanical energy storage member interposed between the lever and the actuating member, and arranged in such a way
   that it is charged when the lever moves towards its triggering position, and
   that it can be discharged when the lever reaches its triggering position, by moving the actuating member towards its actuating position.

The present invention also relates to a watch movement comprising a watch mechanism associated with such a control device, in particular a chronograph mechanism, and to a timepiece comprising such a watch movement.

### STATE OF THE ART

Control devices of this type are already known in the prior art, in particular in connection with chronograph mechanisms.

Patent EP2541346B1 describes an example of a construction of a control device having the above characteristics, intended to enable a flyback function in a chronograph mechanism. To this end, the device comprises a return-to-zero triggering lever comprising a beak arranged to pivot a stepped wheel. More specifically, the triggering lever comprises a beak designed to cooperate with a stop formed on a first plate of the stepped wheel defining a first stage of the latter. The stepped wheel has a second plate defining a second stage, the second plate having the general shape of a heart-shaped cam arranged to cooperate with a control lever for defining the angular orientation of the stepped wheel. The control lever is subjected to the action of a spring to keep a roller that it carries at one of its ends in permanent contact with the periphery of the second plate. The latter comprises a recess that defines an angular rest orientation of the stepped wheel when the roller is housed therein, in the absence of any action by a user. When a user acts on the triggering lever, the movement of the latter causes the stepped wheel to rotate, with the roller then emerging from the recess and rolling along the periphery of the second plate. The radius of the second plate then increases until it reaches the tip of the heart-shaped cam. At the same time, the spring is tensioned, storing mechanical energy. When the triggering lever reaches its triggering position, the roller passes over the tip of the heart-shaped cam, and the spring can release the previously stored mechanical energy, becoming a motor, to make the stepped wheel rotate further and reset the chronograph mechanism. To this end, the stepped wheel comprises a third plate, defining a third stage, on which a reset surface is provided which is intended to cooperate with a reset cam of the chronograph mechanism, in a conventional manner. The stepped wheel continues to rotate under the impulse of the spring until the roller returns to its position in the recess of the second plate. One of the aims of this device is to ensure that the reset cam is released immediately after being returned to its zero position, in order to implement a flyback movement, even if the user maintains his action on the triggering lever. To achieve this objective, this complex construction provides for the spring to be loaded by the movement of the triggering lever but to be discharged by rotating the third plate, defining an actuator for the chronograph mechanism, independently of the position of the triggering lever. If the user does not operate the triggering lever until it reaches its triggering position, the stepped wheel moves backwards under the effect of the spring action until the roller is repositioned in the recess of the second plate. On the other hand, this construction makes it possible to ensure that the chronograph mechanism is completely reset when the triggering lever has completed its travel, which makes the corresponding control device an ‘all-or-nothing’ type device.

Overall, it clearly appears from the figures of this patent how complex this construction is, particularly in view of the large number of its components, and how relatively bulky it is, both in plan and in thickness.

Patent application EP3876042A1 describes a reset device construction for a chronograph mechanism, comprising a return-to-zero hammer held in a rest position by the action of a locking hook on a pin integral with the hammer, the locking hook being rotatably mounted on a frame element of the corresponding watch movement. When a user actuates an associated control member, it loads a hammer actuation spring and causes the locking hook to pivot until the latter releases the pin and therefore the hammer, which can then suddenly move to reset the chronograph mechanism. However, in addition to complex construction and assembly, such a device has a number of disadvantages, in particular a limited level of precision with regard to the moment at which the locking hook releases the pin, this level of precision also depending on the orientation of the mechanism at the moment of actuation of the reset device, as well as any possible movements of the corresponding timepiece, for example due to actuation of the reset control member by the user or other possible shocks. Furthermore, the moment at which the reset device is triggered is bound to fluctuate over time with such a construction, due to the inevitable more or less rapid wear of the pin and, above all, of the locking hook, depending on the number of actuations. It is easy to understand that the slightest change in the shape of the tip of the locking hook will have a significant impact on the time at which this reset device is triggered.

Thus, it may be useful to propose a control device with ‘all-or-nothing’ type operation of simplified construction with reference to existing devices, while still being robust.

### DISCLOSURE OF THE INVENTION

A principal aim of the present invention is to propose a control device of alternative construction to the known constructions of the prior art, presenting in particular greater simplicity both in terms of number of components and of assembling.

To this end, the present invention relates more particularly to a control device of the type mentioned above, characterized
by the fact that it further comprises a locking member intended to be actuated, in response to the action of the user on the external control member, to switch from a locking configuration in which it is held by default by an additional elastic return member to lock the actuating member, to a neutralized configuration in which it releases the actuating member to enable it to actuate the watch mechanism, and
by the fact that the lever and the locking member are arranged in such a way that the switching of the locking member to its neutralized configuration is substantially synchronized with the arrival of the lever in its triggering position.

Thanks to these characteristics, it is possible to produce a control device of relatively simple and robust construction, making it possible to guarantee ‘all-or-nothing’ type operation, perfectly suitable for controlling the return-to-zero function of a chronograph mechanism in particular.

Preferably, the locking member may be arranged to perform reciprocating movements during configuration changes, thus further limiting the size of the control device according to the invention.

Advantageously, the lever may also be arranged to act on the actuating member and move it towards its neutral position when it moves itself towards its rest position. Alternatively, a specific spring can of course be provided to perform this function, but this would involve an increase in the number of components.

According to a preferred embodiment, it may be provided that the energy storage member is made as one with the actuating member and has a portion indirectly or directly bearing against the lever.

It may also be provided that the lever comprises a stop arranged to act on the locking member and move it from its locking configuration to its neutralized configuration in response to the action of the user on the external control member.

Generally speaking, it may also be provided
that the locking member comprises a plate intended to be mounted rotatably on a frame element of the watch movement in such a way that it is situated opposite a beak of the actuating member in order to lock the latter, and
that the plate has a slot intended to be positioned opposite the beak in the neutralized configuration of the locking member, in order to allow displacement of the actuating member by penetration of the beak into the slot.

It may also be provided that the additional elastic return member is intended to be secured to a frame element of the watch movement, while being arranged to exert a return force on the plate and to tend to return the locking member from its neutralized configuration to its locking configuration.

Thanks to the above features, better control of the moment of release of the actuating member is obtained than with the aforementioned prior reset device, in all positions of the corresponding timepiece, including if it is moving. In addition, these characteristics ensure the durability of this control since any wear of the components ensuring the locking has no impact on the instant of release which will remain dictated by the alignment between the slot and the beak, i.e. by the arrival of the lever in its triggering position. In a different way, the more worn the components of the previous reset device are, the earlier the hammer actuation occurs as a function of the movement of the associated control member.

The present invention also relates to a watch movement comprising a watch mechanism associated with a control device according to the above characteristics, more preferably when the watch mechanism is a chronograph mechanism, as well as to a timepiece comprising such a watch movement.

### BRIEF DESCRIPTION OF THE DRAWINGS

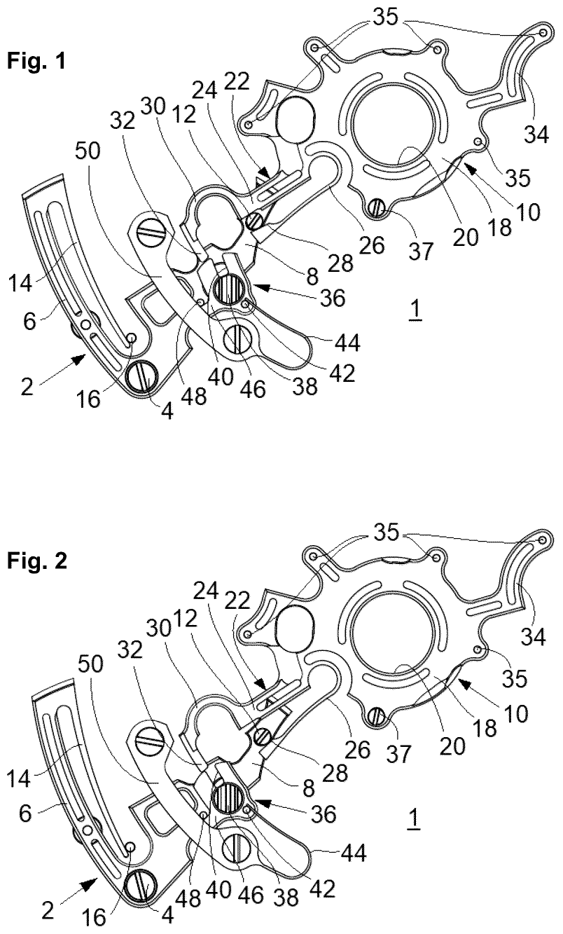

Other features and advantages of the present invention will become clearer on reading the following detailed description of a preferred embodiment, made with reference to the attached drawings given by way of non-limiting examples and in which FIGS. 1 to 4 represent a same simplified front view of a control device according to a preferred embodiment of the present invention, in four successive configurations that it takes when activated by a user.

### EMBODIMENT(S) OF THE INVENTION

FIGS. 1 to 4 show simplified front views of a control device 1 according to a preferred embodiment of the present invention, in four successive configurations that it takes when activated by a user.

The control device 1 comprises a lever 2 intended to be mounted on a frame element (not shown) of the corresponding watch movement, so as to be able to pivot along an axis of rotation defined by its mounting screw 4 on the frame element.

The lever 2 has a first arm 6 extending from its axis of rotation and intended to receive a force exerted by a user, transmitted to the first arm 6 via an external control member (not visible) of the corresponding timepiece, preferably a conventional push-button. Thus, in response to an appropriate action by the user, preferably a pressure applied on a push-button, the lever 2 pivots clockwise in the view of FIGS. 1 to 4.

The lever 2 comprises a second arm 8 intended to cooperate with an actuating member 10 of a watch mechanism of the corresponding watch movement. More specifically, the second arm 8 of the lever 2 carries a stop member, here a screw 12, arranged to project from the second arm 8 so as to be able to cooperate with the actuating member 10 when the lever 2 pivots.

It should be noted that the screw 12 may be replaced by a simple pin, but the use of an eccentric screw, as is the case here, advantageously makes it possible to adjust the relative orientation between the second arm 8 and the actuating member 10.

The lever 2 is advantageously associated with an elastic return member, in this case a straight spring 14 made as one with the first arm 6 and whose free end is intended to bear on a pin 16, integral with the frame of the watch movement, to tend to rotate the lever 2 in the counterclockwise direction of rotation in the view of the figures. In the absence of any action by a user, the lever 2 occupies a default rest position, which may in particular be defined by a stop not shown (provided for example on the main frame or the casing ring, or even on the case of the corresponding timepiece, or even directly provided by the external control member).

For its part, the actuating member 10 has two contact surfaces arranged on either side of the eccentric screw 12, so that the lever 2 can act on the actuating member 10 to cause it to pivot in one direction of rotation or the other.

Indeed, according to the preferred embodiment illustrated in FIGS. 1 to 4, by way of a non-limiting illustrative example, the actuating member 10 has a base 18 provided with a central opening 20 intended to allow the actuating member 10 to be assembled on the frame of the corresponding watch movement, while defining its axis of rotation.

A first arm 22 extends from the base 18 in a substantially radial general direction and has a central portion 24 capable of cooperating with the eccentric screw 12 of the lever 2 to define one of the aforementioned contact surfaces. The actuating member 10 also comprises a spring 26, extending here from the first arm 22 by way of a non-limiting example, and the free end 28 of which defines the second contact surface cooperating with the screw 12 of the lever 2.

The first arm 22 has, after its central portion 24 and moving away from the base 18, a curved terminal portion 30, the free end of which defines a beak 32 of substantially tangential orientation (with reference to the axis of rotation of the actuating member 10).

The actuating member 10 also comprises a second arm 34 intended to actuate the associated watch mechanism (not shown) when the actuating member 10 pivots, here in the counterclockwise direction of rotation in the view of FIGS. 1 to 4.

Of course, the second arm 34 is mentioned here by way of a non-limiting illustrative example, and the person skilled in the art will not encounter any particular difficulty in adapting the actuating member according to his own needs without going beyond the scope of the invention. Thus, it is possible to provide that the actuating member comprises a plurality of arms intended to cooperate with one or more different mechanisms and/or that the actuating member carries stops, possibly of different types, intended to cooperate with one or more different mechanisms (five pins 35, one of which is at the end of the second arm 34, and an eccentric 37 are illustrated here by way of example, which can actuate a same mechanism in different ways and/or at different times, or which can actuate different mechanisms).

The control device 1 also comprises a locking member 36 intended to be mounted on the frame of the watch movement so as to be able to pivot along an axis of rotation defined by the screw 38 for assembling it on the frame. The locking member 36 is in the form of a plate located opposite the beak 32 of the actuating member 10 and provided with a slot 40 into which the beak 32 is able to penetrate, as will become apparent from the remainder of this description.

The plate of the locking member 36 carries a pin 42 defining an abutment for an additional elastic return member 44, the latter being arranged to hold the locking member 36 in a locking configuration (FIGS. 1 and 2), i.e. a configuration in which the slot 40 is not located opposite the beak 32 of the actuating member 10. In addition, the plate has an extension 46 arranged to cooperate with a pin 48 integral with the lever 2, so that rotation of the lever 2 in the clockwise direction of rotation, in the view of FIGS. 1 to 4, can cause rotation of the locking member 36 in the counterclockwise direction of rotation, to possibly cause it to switch to a neutralized configuration, i.e. a configuration in which the slot 40 is located opposite the beak 32, thus allowing the actuating member 10 to pivot.

Alternatively, the elastic return member of the locking member may be made as one with the plate of the locking member 36 and cooperate with a pin integral with the frame of the watch movement, without however departing from the scope of the invention.

It should be noted that the additional elastic return member 44 comprises here a base 50 intended to enable it to be fixed to the frame of the corresponding watch movement, by way of illustration.

Of course, it is also possible to provide, as an alternative, that the elastic return member 44, with its base 50, is made as one with the locking member 36, without departing from the scope of the invention as defined by the appended claims, in particular in order to reduce the number of components and the thickness of the mechanism in the concerned region.

The operating mode of the control device 1 will now be described in relation to its four successive configurations illustrated in FIGS. 1 to 4, corresponding to four successive instants during activation by a user, by suitable action on the external control member of the corresponding timepiece.

FIG. 1 illustrates the configuration of the control device 1 in its initial state, at rest, before being affected by the user's action.

The lever 2 is held in its rest position by the action of the spring 14, which tends to make it pivot in the counterclockwise direction of rotation in the view of FIG. 1.

In this position, the pin 48 of the lever 2 defines an abutment for the locking member 36, in combination with the action of the additional elastic return member 44, to maintain the locking member 36 in its locking configuration, i.e. a configuration in which its slot 40 is not located opposite the beak 32 of the actuating member 10. At the same time, the eccentric screw 12 of the lever 2 is positioned to bear against the central portion 24 of the first arm 22 of the actuating member 10, the lever 2 thus holding the actuating member 10 in a neutral or rest position. The free end 28 of the spring 26 is preferably positioned against the eccentric screw 12 in this configuration, the spring 26 being slightly pre-stressed for this purpose.

FIG. 2 illustrates the configuration of the control device 1 once the lever 2 begins to rotate, clockwise, in response to the user's action on the external control member.

As soon as the lever 2 begins to rotate, the actuating member 10 is subjected to stress in the counterclockwise direction of rotation as seen in FIG. 2, by the action of the eccentric screw 12 on the free end 28 of the spring 26, causing its beak 32 to be held against the plate of the locking member 36 (or to come into contact with it if clearance was provided at rest). Even though the locking member 36 has also begun to rotate, counterclockwise, the angle covered is not sufficient to position the slot 40 opposite the beak 32 of the actuating member 10. The beak 32 therefore remains in contact with the periphery of the plate of the locking member 36, the latter therefore still being in the locking configuration in which it locks the actuating member 10.

At the same time, the spring 14 of the lever 2 is gradually tensioned. As the actuating member 10 cannot pivot yet, its spring 26 deforms under the effect of the action of the eccentric screw 12 of the lever 2. The spring 26 thus acts as a mechanical energy storage member, interposed between the lever 2 and the actuating member 10, so that it can be charged when the lever 2 moves from its rest position to a final triggering position.

If the user were to cease his action on the external control member at this stage, the control device 1 would return directly to its initial state, as illustrated in FIG. 1. Indeed, the lever 2 would be returned to its rest position due to the combined actions of the springs 14 and 26, the eccentric screw 12 thus coming to rest against the central portion 24 of the first arm 22 of the actuating member 10. At the same time, the locking member 36 can pivot in the clockwise direction of rotation until it resumes its initial angular orientation, under the effect of the action of its additional elastic return member 44.

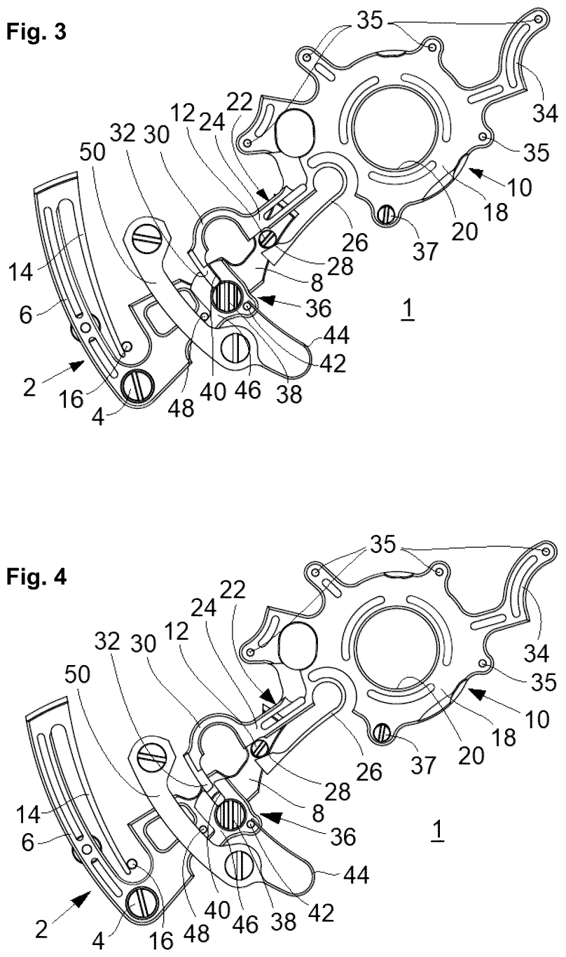

On the other hand, when the user continues to act on the external control member, the control device 1 evolves to the configuration shown in FIG. 3, in which its lever 2 has reached its triggering position.

The locking member 36 has continued to rotate counterclockwise, in the view of FIGS. 2 and 3, until the slot 40 is positioned opposite the beak 32 of the actuating member 10. At this point, the actuating member suddenly becomes free to rotate in the counterclockwise direction, which the mechanical energy stored up to now in the spring 26 encourages it to do quickly, as can be seen from the configuration shown in FIG. 3. Preferably, the travel covered by the eccentric screw 12, when the lever 2 moves from its rest position to its triggering position, corresponds at least to the travel covered by the beak 32 to reach the screw 38 of the locking member 36, when the actuating member 10 moves from its locked position illustrated in FIG. 2 to its actuating position illustrated in FIG. 3. Thus, when the actuating member is positioned in the actuating position illustrated in FIG. 3, the central portion 24 of its first arm 22 moves closer to the eccentric screw 12, without necessarily being in contact with it.

During this rapid rotation movement, the second arm 34 (and any other possible stop, as mentioned above) of the actuating member 10 also moves counterclockwise, in the view of FIGS. 2 and 3, to actuate the watch mechanism(s) with which the control device 1 is associated, for example a member for resetting one or more chronograph counters to zero. It can be seen that the amplitude of movement of the actuating member 10, and therefore of its second arm 34, does not depend directly on that of the lever 2. The triggering of the actioning of the associated watch mechanism is conditioned by the amplitude of movement of lever 2, which must move until it reaches its triggering position. The action of the actuating member 10 on the watch mechanism is then driven by the spring 26, which switches to motor mode by discharging the stored energy once the locking member 36 switches to its neutralized configuration, this switch being substantially synchronized with the arrival of the lever 2 in its triggering position.

When the user releases the lever 2, for example by ceasing his action on the associated external control member, the lever 2 pivots counterclockwise in the view of FIG. 4, under the effect of the action of its spring 14. During this movement, the lever 2 acts on the actuating member 10 by the application of pressure by the eccentric screw 12 on the central portion 24 of the first arm 22, thus causing the actuating member 10 to pivot in the clockwise direction of rotation to return it to its neutral position.

At the same time, the lever 2 releases the locking member 36, its pin 48 moving away from the extension 46. However, the locking member 36 remains locked in its neutralized configuration as long as the beak 32 is engaged in its slot 40 and therefore prevents its plate from rotating. The elastic return member 44 of the locking member 36 thus remains tensioned until the beak 32 has disengaged from the slot 40. Once the beak 32 is out of the slot 40, the additional elastic return member 44 causes the locking member 36 to pivot in the clockwise direction of rotation in the view of FIG. 4 to return it to its locking configuration, the entire control device 1 thus returning to its initial configuration as illustrated in FIG. 1.

It can be seen that the locking member 36 performs a reciprocating movement each time the control device 1 is activated by the user, which makes it possible to further limit the size of the device according to the present invention.

The foregoing description shows how it is possible to produce a control device for a watch mechanism with ‘all-or-nothing’ type operation that is very simple to construct and assemble, and takes up very little space since the components are distributed over only two levels in the direction of the thickness of the control device. It should be noted that it is even possible to modify the shape of the components just described to produce the control device according to the invention on a single level. It is clearly understood that the various components of the control device according to the invention can also have very different shapes without this affecting their functionality, which gives a watch movement manufacturer great flexibility in distributing the various components involved, including those of the associated watch mechanism. Furthermore, while the control device according to the present invention is perfectly suitable for implementation with operating parameters adapted to a conventional chronograph mechanism, in particular a corresponding pusher travel of the order of 0.8 to 1 mm and an actuating force of the order of 8 to 12 N, it can also be implemented with particular mechanisms having reduced operating values, for example a pusher stroke of the order of 0.3 mm and a force of the order of 1.5 to 2.5 N.

The foregoing description is intended to describe a particular embodiment by way of non-limiting illustration, and the invention is not limited to the implementation of certain particular features just described, such as, for example, the fact that certain elastic members are made as one with particular components of the device. Indeed, the various elastic members of the control device as just described could be constructed differently (in particular by reversing their implantation), the spring interposed between the lever and the actuating member could in particular be carried by the lever as an alternative to what has been described, or it could be envisaged that the device comprises a specific additional elastic return member to return the actuating member to its neutral position, without departing from the scope of the invention as defined by the appended claims. Generally speaking, it may be provided as an alternative that some or all of the various moving components of the control device according to the present invention, i.e. the lever and/or the actuating member and/or the locking member, move in translation, possibly linearly, rather than in rotation as described. Furthermore, the person skilled in the art will of course be able to adapt the present teaching by associating the control device with a watch mechanism other than a chronograph mechanism, without however departing from the scope of the invention as defined by the appended claims.

1.-10. (canceled)

11. A control device, for a watch movement, comprising:
a lever intended to be actuated, in response to an action by a user on an external control member, to move from a rest position to a triggering position,
an elastic return member arranged to return said lever to its rest position,
an actuating member movable between a neutral position and an actuating position in which it is intended to actuate a watch mechanism of the watch movement,
a mechanical energy storage member interposed between said lever and said actuating member, and arranged in such a way
that it is charged when said lever moves towards its triggering position, and
that it can be discharged when said lever reaches its triggering position, by moving said actuating member towards its actuating position,
wherein the control device further comprises a locking member intended to be actuated, in response to the action of the user on the external control member, to switch from a locking configuration, in which said locking member is held by default by an additional elastic return member to lock said actuating member, to a neutralized configuration, in which said locking member releases said actuating member to enable it to actuate the watch mechanism, and
wherein said lever and said locking member are arranged in such a way that the switching of said locking member to its neutralized configuration is substantially synchronized with the arrival of said lever in its triggering position.

12. The control device of claim 11, wherein said locking member is arranged to perform reciprocating movements between said locking configuration and said neutralized configuration.

13. The control device of claim 11, wherein said lever is also arranged to act on said actuating member and move it towards said neutral position when said lever moves itself towards said rest position.

14. The control device of claim 12, wherein said lever is also arranged to act on said actuating member and move it towards said neutral position when said lever moves itself towards said rest position.

15. The control device of claim 11, wherein said mechanical energy storage member is made as one with said actuating member and has a portion indirectly or directly bearing against said lever.

16. The control device of claim 13, wherein said mechanical energy storage member is made as one with said actuating member and has a portion indirectly or directly bearing against said lever.

17. The control device of claim 14, wherein said mechanical energy storage member is made as one with said actuating member and has a portion indirectly or directly bearing against said lever.

18. The control device of claim 11, wherein said lever comprises a stop arranged to act on said locking member and move it from said locking configuration to said neutralized configuration in response to the action of the user on the external control member.

19. The control device of claim 13, wherein said lever comprises a stop arranged to act on said locking member and move it from said locking configuration to said neutralized configuration in response to the action of the user on the external control member.

20. The control device of claim 14, wherein said lever comprises a stop arranged to act on said locking member and move it from said locking configuration to said neutralized configuration in response to the action of the user on the external control member.

21. The control device of claim 17, wherein said lever comprises a stop arranged to act on said locking member and move it from said locking configuration to said neutralized configuration in response to the action of the user on the external control member.

22. The control device of claim 11,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

23. The control device of claim 13,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

24. The control device of claim 14,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

25. The control device of claim 17,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

26. The control device of claim 19,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

27. The control device of claim 21,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

28. The control device of claim 27, wherein said additional elastic return member is intended to be secured to a frame element of the watch movement while being arranged to exert a return force on said plate and to return said locking member from said neutralized configuration to said locking configuration.

29. A watch movement comprising a watch mechanism associated with a control device comprising:
a lever intended to be actuated, in response to an action by a user on an external control member, to move from a rest position to a triggering position,
an elastic return member arranged to return said lever to its rest position,
an actuating member movable between a neutral position and an actuating position in which it is intended to actuate a watch mechanism of the watch movement,
a mechanical energy storage member interposed between said lever and said actuating member, and arranged in such a way
that it is charged when said lever moves towards its triggering position, and
that it can be discharged when said lever reaches its triggering position, by moving said actuating member towards its actuating position, wherein the control device further comprises a locking member intended to be actuated, in response to the action of the user on the external control member, to switch from a locking configuration, in which said locking member is held by default by an additional elastic return member to lock said actuating member, to a neutralized configuration, in which said locking member releases said actuating member to enable it to actuate the watch mechanism, and
wherein said lever and said locking member are arranged in such a way that the switching of said locking member to its neutralized configuration is substantially synchronized with the arrival of said lever in its triggering position.

30. The watch movement of claim 29, wherein said locking member is arranged to perform reciprocating movements between said locking configuration and said neutralized configuration.

31. The watch movement of claim 29, wherein said lever is also arranged to act on said actuating member and move it towards said neutral position when said lever moves itself towards said rest position.

32. The watch movement of claim 30, wherein said lever is also arranged to act on said actuating member and move it towards said neutral position when said lever moves itself towards said rest position.

33. The watch movement of claim 29, wherein said mechanical energy storage member is made as one with said actuating member and has a portion indirectly or directly bearing against said lever.

34. The watch movement of claim 29, wherein said lever comprises a stop arranged to act on said locking member and move it from said locking configuration to said neutralized configuration in response to the action of the user on the external control member.

35. The watch movement of claim 32, wherein said lever comprises a stop arranged to act on said locking member and move it from said locking configuration to said neutralized configuration in response to the action of the user on the external control member.

36. The watch movement of claim 29,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

37. The watch movement of claim 35,
wherein said locking member comprises a plate intended to be mounted rotatably on a frame element of the watch movement in such a way that said plate is situated opposite a beak of said actuating member in order to lock said actuating member, and
wherein said plate has a slot intended to be positioned opposite said beak in said neutralized configuration of said locking member, in order to allow displacement of said actuating member by penetration of said beak into said slot.

38. The watch movement of claim 29, wherein said watch mechanism is a chronograph mechanism comprising at least one return-to-zero lever arranged to be actuated by said actuating member in response to the action of the user on the external control member.

39. The watch movement of claim 37, wherein said watch mechanism is a chronograph mechanism comprising at least one return-to-zero lever arranged to be actuated by said actuating member in response to the action of the user on the external control member.

40. A timepiece comprising a watch movement including a watch mechanism associated with a control device comprising:
a lever intended to be actuated, in response to an action by a user on an external control member, to move from a rest position to a triggering position,
an elastic return member arranged to return said lever to its rest position,
an actuating member movable between a neutral position and an actuating position in which it is intended to actuate a watch mechanism of the watch movement,
a mechanical energy storage member interposed between said lever and said actuating member, and arranged in such a way
that it is charged when said lever moves towards its triggering position, and
that it can be discharged when said lever reaches its triggering position, by moving said actuating member towards its actuating position,
wherein the control device further comprises a locking member intended to be actuated, in response to the action of the user on the external control member, to switch from a locking configuration, in which said locking member is held by default by an additional elastic return member to lock said actuating member, to a neutralized configuration, in which said locking member releases said actuating member to enable it to actuate the watch mechanism,
wherein said lever and said locking member are arranged in such a way that the switching of said locking member to its neutralized configuration is substantially synchronized with the arrival of said lever in its triggering position, and
wherein the timepiece further comprises an external control member arranged to act on said lever in response to a predefined action of a user thereon, to move said lever towards its triggering position.
